(19) United States
(12) Patent Application Publication
(10) Pub. No.: US 2008/0180302 A1
(43) Pub. Date: Jul. 31, 2008

(54) Universal remote control

(75) Inventor: Alan Amron, New York, NY (US)

Correspondence Address: Alfred W. Froebrich, Esq.;Cohen Pontani Lieberman & Pavane LLP, Suite1210, 551 Fifth Avenue, New York, NY, 10176, US

(73) Assignee: Digital Video Chip, LLC

(21) Appl. No.: 11/726,784

(22) Filed: Mar. 23, 2007

Related U.S. Application Data
(63) Continuation-in-part of application No. 11/704,847, filed on Feb. 9, 2007.
Application No. 11/704,847 is a continuation-in-part of application No. 11/698,699, filed on Jan. 26, 2007.

(51) Int. Cl. G08C 19/12

(52) U.S. Cl. 341/176

(57) ABSTRACT

A universal remote control device is presented. The universal remote control device includes a mechanism for communicating with a host device that includes a video display, an audio output, and a microprocessor. The universal remote control device further includes a media slot configured to receive a removable memory device. The removable memory device includes an entertainment application and a script file or command file. The entertainment application includes primary data that includes at least one media file. The script file or command file is readable or executable by the remote control device or the host device upon insertion of the memory device into the media slot or upon activating the remote control device or the host device after the memory device is inserted in the media slot. The script file or command file includes a request for the host device to display or play the at least one media file.

### CROSS REFERENCE TO RELATED APPLICATIONS

The present application is a Continuation-In-Part of U.S. patent application Ser. No. 11/704,847, filed on Feb. 9, 2007, which is a Continuation-In-Part of U.S. patent application Ser. No. 11/698,699, filed on Jan. 26, 2007, the entire contents of which are expressly incorporated herein by reference.

### BACKGROUND OF THE INVENTION

1. Field of the Invention

The present invention relates generally to a universal remote control, and more particularly to a universal remote control that includes a media slot for receiving a memory device that stores at least one media file (e.g., audio, video, audio and video, or still images) or a game application that is automatically played or executed by an electronic host device that is in communication with the remote control when the memory device is inserted into the memory slot.

2. Description of the Related Art

Electronic devices with visual or audiovisual displays are commercially available in many formats, including such dedicated devices as televisions, projectors, laptop and desktop computers, game devices such as Nintendo Gameboy, Nintendo color Gameboy, Sony Playstation PSP, as well as devices running Windows operating systems and compatible operating systems, such as those from Sony, NEC, Hewlett Packard, and Palm Pilot, Motorola, SamSung, Nikon, Kodak, Sony, and Cannon. The user of such devices must typically navigate through a sequence of menus and configuration screens before the actual game or video application. For example, in a typical game the user must elect whether he or she will be playing in accordance with one set of game rules for a single player stand-alone mode, wherein the only opponent is the computer, or with a different set of game rules in the multiple player networked player game mode, where each of the user's interactions causes responses in accordance with a fixed set of defined rules. In either case, the user's conduct and results are visceral, that is, he wins, he loses, he gains or loses a physical possession such as a sword or power pill, and he uses up some amount of time, energy, points, etc. in the process of playing the game, which ultimately determines how long he is allowed to play the game.

Instead of playing a competitive game, it is desirable in some instances to have an electronic apparatus launch entertainment applications which are not characterized by the notion of winning or losing, more specifically, entertainment applications adapted to entertain without any preliminary configuration or other input on the part of the user, other than to simply insert a memory cartridge with digital content on it aim at player device and transmit control to operate that content on your host device. Or have the media slot in the receiver side connected via hard wire RCA or S-Video in and controlled by the universal remote.

Some electronic devices have on-board content such as games, video clips and audio. However, the applications are limited to what the specific electronic device manufacturer has loaded on to it. Furthermore, some electronic devices also allow applications to be downloaded. However, this feature uses on-board memory space and is thus limited by the available on-board memory space.

### SUMMARY OF THE INVENTION

In one aspect, the invention involves a universal remote control device. The universal remote control device includes means for communicating with a host device, the host device including a video display, audio output, and a microprocessor, and a media slot configured to receive a removable memory device. The removable memory device includes an entertainment application that includes primary data that includes at least one media file, and a script file or command file that is readable or executable by the remote control device or the host device upon insertion of the removable memory device into the media slot or upon activating the remote control device or the host device after the removable memory device is inserted in the media slot. The script file or command file includes a request for the host device to display or play the at least one media file.

In one embodiment, the removable memory device further includes a startup image and the script file or command file further includes a request for the host device to display the startup image before displaying the at least one media file. In another embodiment, the removable memory device further includes a menu image of available menu choices and the script file or command file further includes a request for the host device to display the menu image before displaying the at least one media file.

In one embodiment, the primary data further includes a plurality of formats of the at least one media file, and the script file or command file further includes instructions enabling the host device to locate an appropriate one the plurality of formats of the at least one media file. The script file or command file further include instructions for enabling the host device to determine which one of the plurality of formats to use.

In another embodiment, the universal remote control further includes a decoder for decoding the at least one media file on the universal remote control device to produce decoded information that is capable of being transmitted to the host device for display. In still another embodiment, the removable memory device is a portable memory device. In another embodiment, the universal remote control further includes a file that is executable on the removable memory device. In yet another embodiment, the removable memory device includes one of mini SD, SD, compact flash, memory stick, memory storage card, or mini hard drive.

In other embodiments, the host device is a mobile terminal, one of a mobile phone, digital camera, and personal digital assistant, a television, or a set top box in communication with a television or a video monitor.

In another aspect, the invention involves a method of displaying or playing an entertainment application on a host device. The method includes providing a removable memory device that includes a script file or command file, and an entertainment application that includes primary data that includes at least one media file. The method further includes providing a universal remote control device that includes a media slot configured to receive the removable memory device. The script file or command file is readable or executable by the remote control device or the host device upon insertion of the removable memory device into the media slot or upon activating the remote control device or the host device after the memory device is inserted in the media slot. The script file or command file includes a request for the host device to display or play the at least one media file. The method further includes inserting the removable memory device into the media slot, providing to the host device, by the universal remote control device, the request for the host device to display or play the at least one media file, and displaying or playing by the host device the at least one media file in response to the request.

In one embodiment, the removable memory device further includes a startup image and the step of displaying includes displaying, by the host device, the startup image prior to displaying or playing the at least one media file. In another embodiment, the step of displaying or playing includes displaying or playing the at least one media file in response to the request after the startup image is displayed and after a user inputs a display or play command to the universal remote control device. The user input is provided using manipulable buttons or switches disposed on the universal remote control device, or using a touch screen on the host device.

In still another embodiment, the memory cartridge further includes a menu image and the step of displaying or playing further includes displaying, by the host device, the menu image prior to displaying or playing the at least one media file in response to the request. The menu image displays at least one item related to a section of the at least one media file, and the step of displaying or playing further includes displaying or playing the at least one section of the at least one media file in response to a user input.

In yet another embodiment, the script file or command file further includes a separate request for each of a plurality of different host devices or for each of a plurality of groups of devices. In still another embodiment, the method further includes providing a decoder on the universal remote control device for decoding the at least one media file on the universal remote control device.

In other embodiments, the universal remote control device further includes a decoder, and the step of displaying or playing includes decoding the at least one media file and transmitting a stream of decoded data from the universal remote control to the host device for display or playback.

In another embodiment, the method includes providing instructions to the host device by executing a program on the universal remote control device and transmitting the instructions to the host device. In other embodiments, the step of displaying or playing further includes pausing the displaying or playing of the at least one media file in response to a user input command to revert to the normal function of the host device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, like reference characters denote similar elements throughout the several views.

FIG. 1 is a block diagram depicting the components of a memory cartridge and host device according to an embodiment of the present invention.

FIG. 2 is a block diagram of another embodiment of a memory cartridge according to FIG. 1.

FIG. 3 is a block diagram of another embodiment of a memory cartridge according to FIG. 1.

FIG. 4 is a rear view of a digital camera which may be used as a host device.

FIG. 5 is a rear view of PDA which may be used as a host device.

FIG. 6 is a flow diagram showing the basic steps according to an embodiment of the present invention.

FIG. 7 is a flow diagram according to a further embodiment of the present invention.

FIG. 8 is a flow diagram according to a further embodiment of the present invention.

FIG. 9 is a flow diagram according to yet another embodiment of the present invention.

FIG. 10 is a flow diagram according to still another embodiment of the present invention.

FIG. 11 is a rear view of a television embodiment displaying a video according to the invention.

FIG. 12 is a rear view of a cell phone embodiment displaying an amusement according to the invention.

FIG. 13 is a schematic diagram illustrating a television connected to an interface for playing an entertainment application on a memory cartridge.

FIG. 14 is an illustrative perspective diagram of a univerisal remote control and a set top box in communication with a television, according to one embodiment of the invention.

FIG. 15A is an illustrative top view of a universal remote control, according to one embodiment of the invention.

FIG. 15B is an illustrative rear view of a universal remote control, according to one embodiment of the invention.

FIG. 15C is an illustrative front view of a universal remote control, according to one embodiment of the invention.

FIG. 15D is an illustative side view of a universal remote control, according to one embodiment of the invention.

FIG. 15E is an illustative bottom view of a universal remote control, according to one embodiment of the invention.

FIG. 16 is an illustative top view of a memory cartridge including a video chip, according to one embodiment of the invention.

FIG. 17A is an illustrative front view of a set top box, according to one embodiment of the invention.

FIG. 17B is an illustrative rear view of a set top box, according to one embodiment of the invention.

FIGS. 18A and 18B are an illustrative flow diagrams of the operation of the universal remote control and set top box shown in FIG. 14, according to one embodiment of the invention.

### DETAILED DESCRIPTION OF THE PRESENTLY PREFERRED EMBODIMENTS

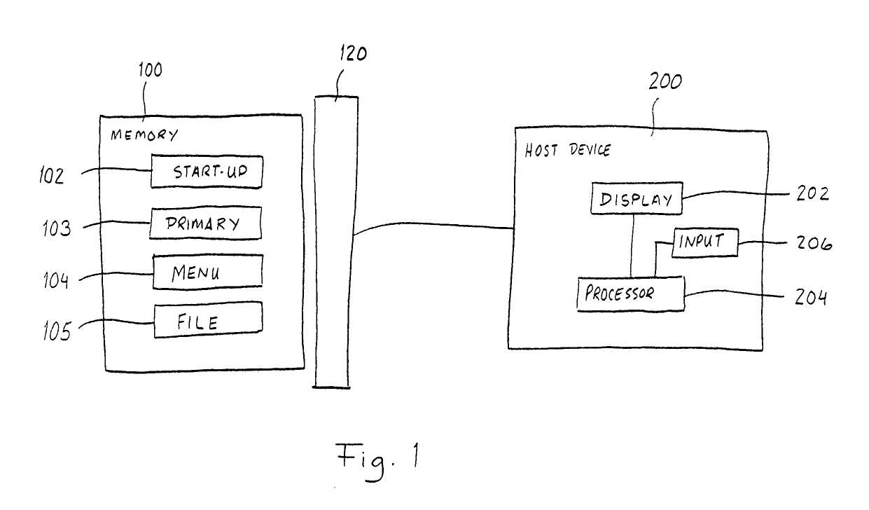

FIG. 1 is a block diagram showing the memory cartridge 100 according to an embodiment of the present invention. The memory cartridge 100 is preferably a portable memory device such as, for example, Mini SD, SD, Compact flash, Sony Stick, or Memory Storage Card, mini hard drive, or any other known or hereafter developed memory storage device. The memory cartridge 100 is removably receivable in an interface 120, which is connected to a host device (i.e., electronic device) 200. The interface 120 is either an integral part of the host device 200 or a peripheral device that is connected to the host device 200 by, for example, a wired or wireless connection.

The host device 200 includes any device that is capable of displaying or playing audio, video, audiovisual, or still image media. For example, the host device 200 can include televisions, projectors, laptop and desktop computers, game devices (e.g., Nintendo Gameboy, Nintendo color Gameboy, Sony Playstation PSP), cell phones, digital cameras, personal digital assistants, and digital voice recorders. The host device 200 can also include devices running Windows operating systems and compatible operating systems, such as those from Sony, NEC, Hewlett Packard, and Palm Pilot, Motorola, SamSung, Nikon, Kodak, Sony, and Cannon. The host device 200 includes at least a display 202, a microprocessor 204, and an input device 206 allowing a user to input commands to the host device 200. The input device 206 typically includes manipulable buttons and/or switches on the host device 200 or a the display 202 (e.g., a touchscreen). Alternatively or additionally, the input device 206 may include voice recognition, or any other known or hereafter developed input means.

The memory cartridge 100 includes an entertainment application. The entertainment application may include a movie, cartoon, television program, song, amusement, or game. The entertainment application includes primary data 103. The primary data 103 includes at least one media file, which can be an audio component or file, a video component or file, an audio with video component or file, and/or still images. The video and audio files include formats that are known in the art, such as .MPEG1-4, .AVI, .WMV, .MOV, .RA, .WMA, .MP3, .WAV, for example. The still image files include formats such as .JPEG, TIFF, .BMP, GIF, etc.

According one embodiment of the invention, the host device 200 is programmed to check the memory cartridge 100 for the primary data 103 (i.e., the at least one media file) upon insertion of the memory cartridge 100 into the interface 120, or upon turning on the host device 200 with the memory cartridge 100 already inserted in the interface 120. In this case, the host device 200 finds the primary data 103 and displays and/or plays video and/or audio files associated with the primary data 103. Alternatively, the host device 200 may check the memory on the memory cartridge 100 for an instruction set. For this purpose, the memory cartridge 100 also includes a script file or command file 105, which includes a request for the host device 200 to display or play the primary data 103 (i.e., the at least one media file). The script file 105 includes the information and instructions necessary for the host device 200 to find and play the primary data 103. The script or command file 105 may be configured for a specific host device 200. Alternatively, the script file 105 may include separate instructions for a plurality of different host devices 200. Each separate set of instructions may be directed to one of the host devices 200 or a group of the host devices 200 (i.e., all Sony digital cameras). The script file 105 may be an executable file that is run by the host device 200.

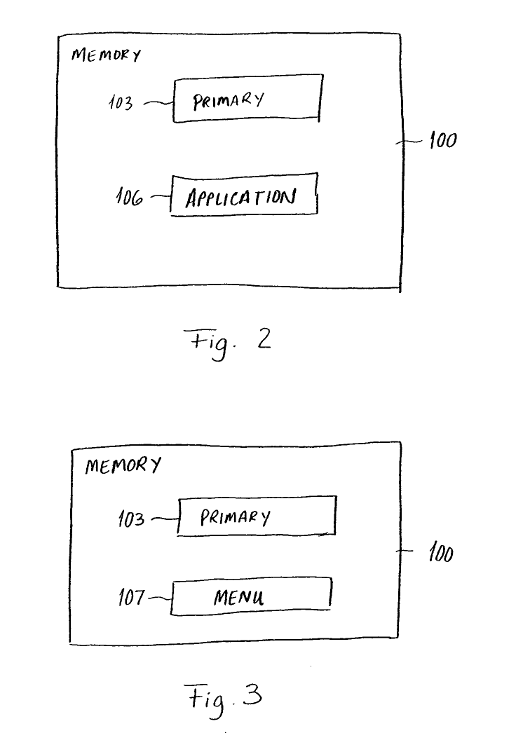

In yet another embodiment, the memory cartridge 100 includes a program or application 106 (see FIG. 2) that is executed by the memory cartridge 100 for generating a signal or other instruction and transmitting the signal or instruction to the microprocessor 204 of the host device 200. The signal or instruction includes a request for the host device 200 to display or play the primary data 103. In this embodiment, the memory cartridge 100 includes some processing capabilities for executing the application or program 106 when the memory cartridge 100 is first powered up (i.e., first receives power), which is usually via pins in the interface 120. The program or application 106 may also include separate instructions for a plurality of different host devices 200 as described above.

The memory cartridge 100 may also include a separate data section called startup data 102 which includes an startup image to be displayed before the video and/or audio files associated with the primary data 103 of the entertainment application is displayed or played. In this case, the startup image is displayed indefinitely upon initiation of the memory cartridge 100. The entertainment application is played only upon receiving an input signal from the user indicating that the entertainment application is to be displayed. This can be accomplished using the input device 206.

Alternatively or additionally, the memory cartridge 100 includes a separate data section called menu data 104. In this embodiment, the menu data 104 includes a menu image, which is displayed before the video and/or audio components associated with the primary data 103 of the entertainment application is displayed. In a specific embodiment, the entertainment application includes different sections (i.e., separate episodes of a show, separate cartoons or other short programs, or separate starting points in the overall program). When the menu image is displayed, the input device 206 of the host device 200 may be used to select one of the menu items. When selected, the section of the entertainment application associated with the selected menu item is displayed.

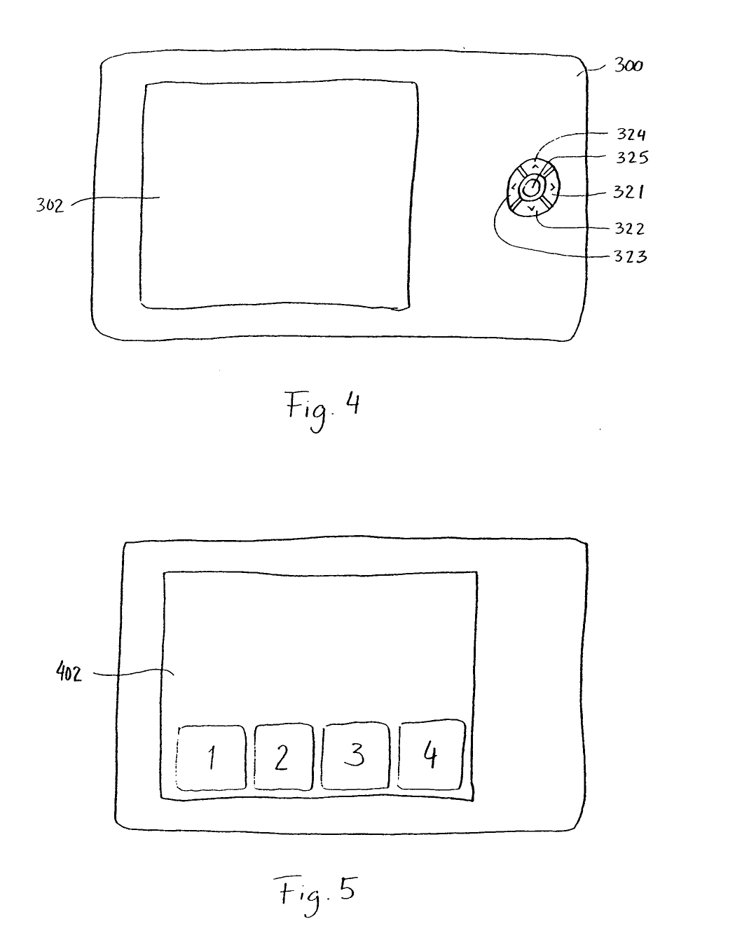

In yet another embodiment, the memory cartridge 100 includes function set data 107 (see FIG. 3), which defines functions associated with various input means associated with the host device 200. The function set data 107 may be provided to the host device 200 as part of the file 105 in the embodiment of FIG. 1, or as part of the application 106 in the embodiment of FIG. 2. For example, a digital camera 300 shown in FIG. 4 includes a display 302 and includes input buttons 321, 322, 323, 324, and 325. Each of these buttons 321, 322, 323, 324, and 325 may be assigned a different function. For example, button 325 may be associated with “play”, button 322 may be associated with “pause”, button 323 with “rewind”, button 321 with “fast forward”, and button 324 may be associated with an “escape” function which switches the device from displaying the application on the cartridge to a normal function of the device. The “escape” function is applicable to a cell phone, wherein a cell phone user may want to stop or pause playback of the entertainment application if a phone call is received. After completing the call, the user may restart the entertainment application from the place where the entertainment application was stopped or paused. Alternatively, the host device 200 may automatically resume playback.

Different devices such as, for example, cell phones have different input devices, which may be assigned various functions dependent on the requirements of the entertainment application. Other functions associated with audio and/or video reproductions, which are known or hereafter developed may also be assigned to various buttons and/or switches on the host device 200. Instead of buttons and switches, the functions may be associated with various areas on a touchscreen input device.

FIG. 5 is an example of a touchscreen 402 on a host device 400 which shows various areas 1, 2, 3, 4 associated with functions on the touchscreen 402. Each area on the touchscreen 402 may be associated with a different function for the entertainment application associated with the memory cartridge 100. Furthermore, some electronic devices, which include controllers for playing back video may have the basic playback functions permanently assigned to specific input devices. In that case, the assignment of a function set to an input device is not necessary. The host device 400 simply uses the existing controls to control playback of the entertainment application on the memory cartridge 100.

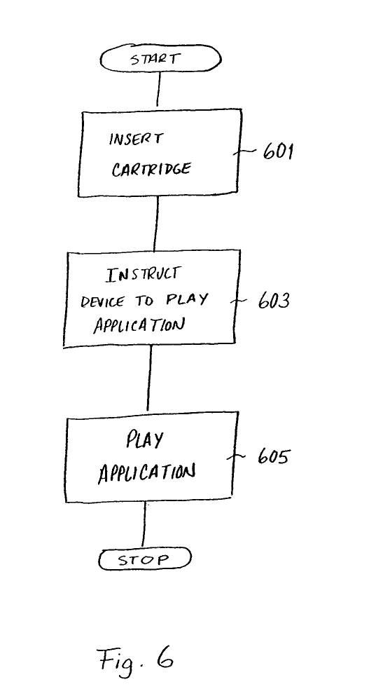

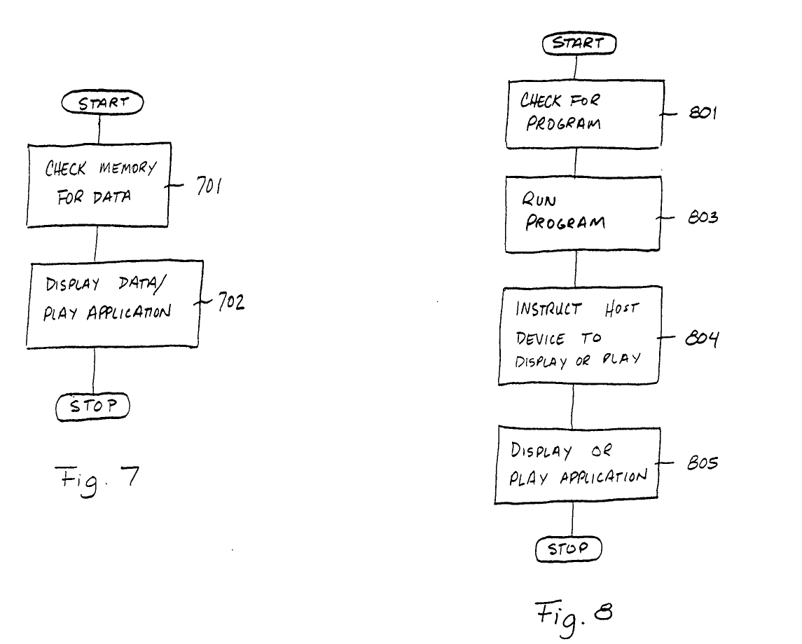

FIG. 6 illustrates a flow diagram of the basic steps according to the present invention. First, a memory cartridge 100 is inserted in an interface 120 connected to the host device 200 (step 601. The host device 200 is instructed or requested to play the entertainment application on the memory cartridge 100 (step 603). As described below, the instruction may be generated in the host device 200 itself or by the memory cartridge 100. In response to the instruction, the host device 200 plays the application (step 605).

FIG. 7 illustrates a simple embodiment in which the host device 200 automatically checks the memory cartridge 100 for primary data 103 (step 701). Step 701 may be preprogrammed in the firmware resident on the host device 200. Alternatively, the original firmware of the host device 200 could be updated to perform this specific function as part of an upgrade to the host device 200 for providing the function associated with playing the memory cartridge 100. Once the displayable data is determined, the host device 200 downloads the data from the memory device 100 and plays the entertainment application (step 703).

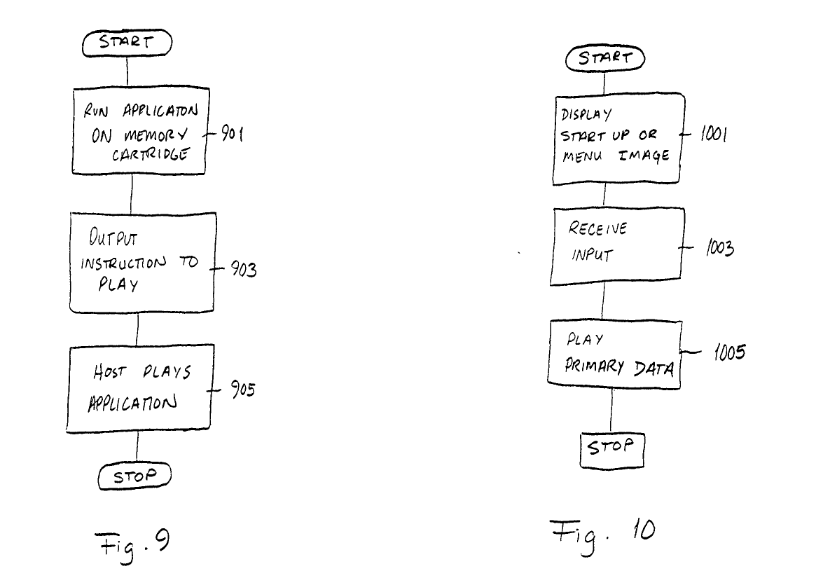

FIG. 8 illustrates a further embodiment in which the host device 200 checks for a script file 105 or an executable program 106 on the memory cartridge 100 (step 801). In this embodiment, the program or application 106 is executed and provides or generates instructions to display or play the entertainment application on the memory cartridge 100 (step 803). The program or application 106 may be executed automatically by a program in the host device 200 such as an autorun or other program upon insertion of the memory cartridge 100 in the interface 120. In response to these instructions, the host device 200 plays the entertainment application (step 807).

In effect, the program or application 106 on the memory cartridge 100 takes over control of the camera operating system. One way to accomplish this is to have the host device 200 programmed to recognize the memory cartridge 100. As stated above, this can be preprogrammed into the firmware resident on the host device 200. However, if the firmware is not programmed to recognize the memory cartridge 100, the memory cartridge 100 can be coded to make the host device 200 believe that the program or application 106 on the memory cartridge 100 is a firmware upgrade. Devices in which firmware is upgradeable typically check an inserted memory cartridge 100 to determine whether it contains a firmware upgrade. This may be indicated by a specific file at a specific location or some other signal know or hereafter developed. If the memory cartridge 100 is found to contain such signal, file, or indication, the host device 200 does not enter the normal operating routine and follows the instructions on the memory cartridge 100 for upgrading the firmware. Accordingly, the memory cartridge 100 of the present invention may include such an indication of a firmware upgrade to take control of the camera and have the camera or other host device 200 follow the instructions in the program or application 106 to play or display the audio and/or video components of the entertainment application.

FIG. 9 illustrates yet another embodiment in which the memory cartridge 100 has processing capabilities. A program or application 106 stored on the memory cartridge 100 is executed by the memory cartridge 100 itself (step 901). The program or application 106 causes the memory cartridge 100 to output a signal instructing the host device 200 to play the entertainment application (step 903). In response to the instructions, the host device 200 plays the entertainment application (step 905).

As stated above, the memory cartridge 100 may include menu data 104 or startup image data 102 in addition to the primary data 103. In each of the steps 605, 703, 807, and 905, the host device 200 first displays the startup data 102 or menu data 104 and waits for input (step 1001 in FIG. 10). Upon receiving an input (step 1003), the host device 200 determines how to play the primary data 103 (step 1005). As described above, this may include starting at a specific section of the primary data 103 or performing a certain task (i.e., play, fast forward, rewind, etc). As further stated above, functions can be associated with specific keys through the application 106 or the script file 105 stored on the memory cartridge 100.

In each of the steps 805 and 903, the instructions may include a plurality of different versions for different devices. The instructions may include steps that instruct the host device to determine a model number or other identifier of the host device 200, and then to use version one if the host device is, for example, a SONY camera and use version two if the host device is a PANASONIC camera.

The entertainment applications to be displayed or played on the host device 200 may include amusement applications such as ETCH-A-SKETCH, or games such as MONOPOLY. In these cases a startup image 102 is displayed and the subsequent images are based on the user input. For example, the ETCH-A-SKETCH application first displays a startup screen that is a blank screen. The user draws on the display using the input device and as the user “draws”, the image is updated to reflect the “drawing” created by the user. In the MONOPOLY application, a user plays the game using the user input device. In this case, the buttons, switches, or touchscreen areas have specifically defined functions such as moving a player along the board, buying a property, etc. By way of further example, the memory cartridge 100 may store video and audio so that the host device 200 would display video or play audio (e.g. cartoons, feature films and/or music albums) controlled by the input by the user—Volume up, Volume down, Play, Pause, Stop, Forward, Reverse, FF, FR, Esc.—upon insertion of the memory cartridge 100 in the interface 120.

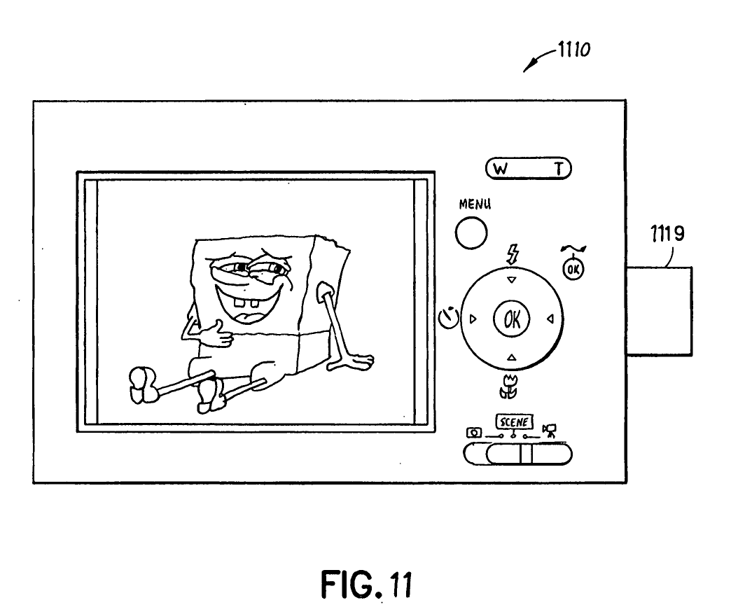

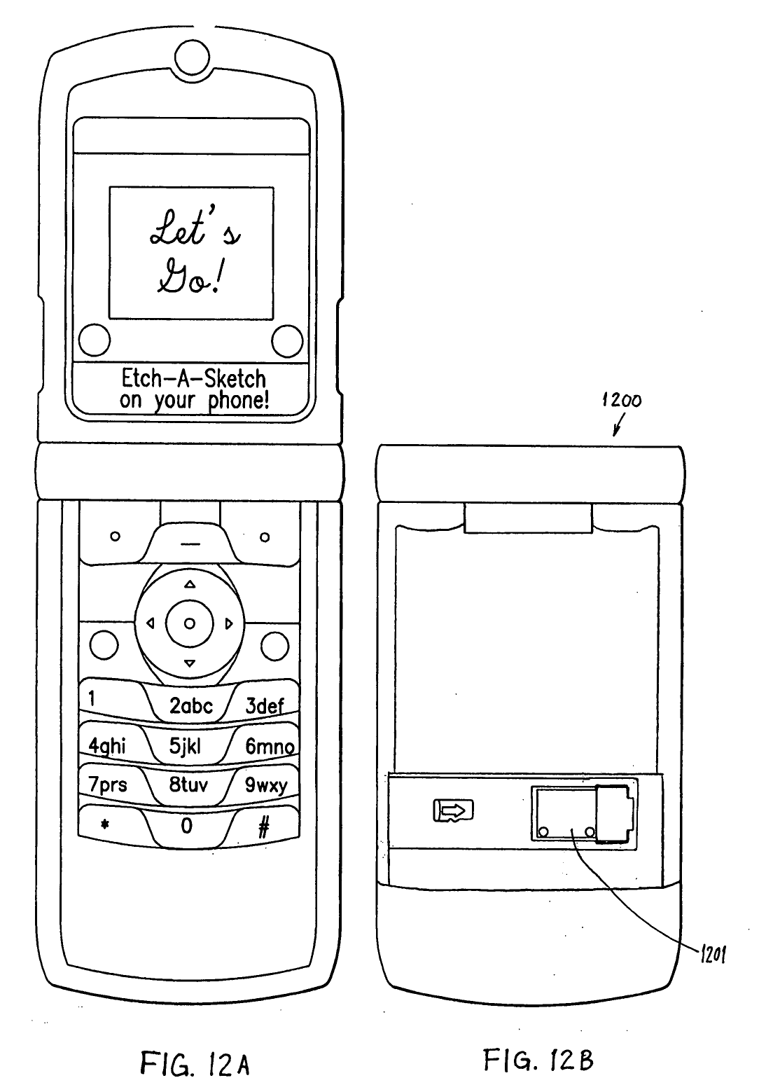

FIG. 11 is an embodiment showing a video from a memory cartridge 1119 being displayed on a display of a television 1110. FIGS. 12A and 12B show a cell phone embodiment in which an ETCH-A-SKETCH amusement image from a memory cartridge 1201 is shown on the display of the cell phone 1200.

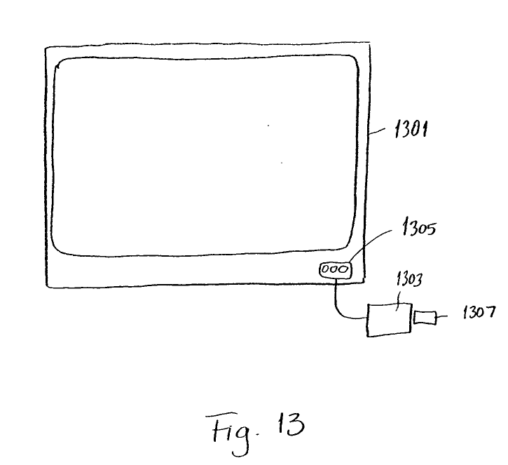

As further shown in the diagram of FIG. 13, the host device may be a television 1301. In this case an interface 1303 may be plugged into or connected to an audio/visual connector 1305 on the television 1301. If the television does not have a video decoder, the video decoder may be contained or stored on the memory cartridge 1307, which is inserted into the interface 1303. The memory cartridge 1307 may comprise any of the embodiments disclosed above. Thus a movie or other video may be viewed without a DVD player or other video player.

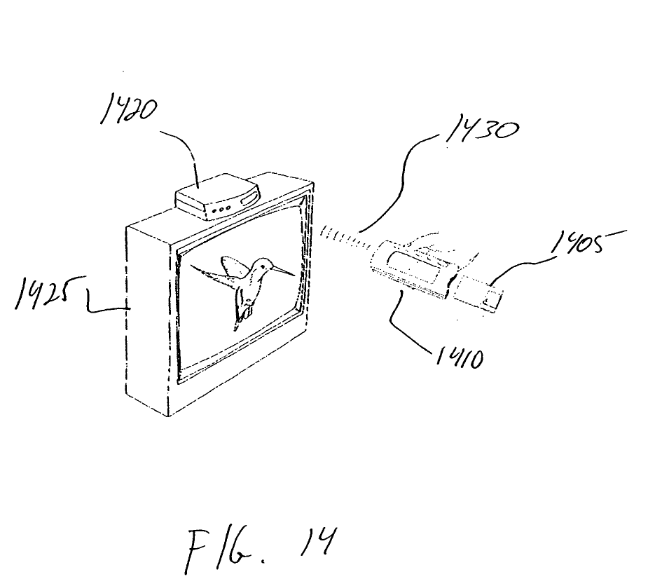

Referring to FIG. 14, in another embodiment, the invention involves a universal remote control 1410 that is configured to receive a removable memory device 1405 (e.g., the memory cartridge 100) that includes a media file (e.g., an audio file, a video file, a video with audio file, and/or a still picture file), or a game application. The media file is played, or the game application is executed when the memory device 1405 is inserted into the universal remote control 1410 either upon insertion of the memory device 1405 into the media slot 1510 or upon insertion of the memory device 1405 into the media slot 1510 and operation of the universal remote control 1410 by a user (e.g., a play button is pressed).

Upon insertion of the memory device 1405, the universal remote control 1410 transmits audio/video data as a wireless signal 1430 (i.e., an infrared (IR) or radio frequency (RF) signal) via wireless transmitter 1515 to a host device, such as a set top box 1420 (or other device capable of receiving wireless signals and displaying or playing a media file) that is connected to, or includes a video monitor or television 1425. The set top box 1420 receives the wireless audio/video signal 1430 and transmits the audio/video signal to a television 1425 for display.

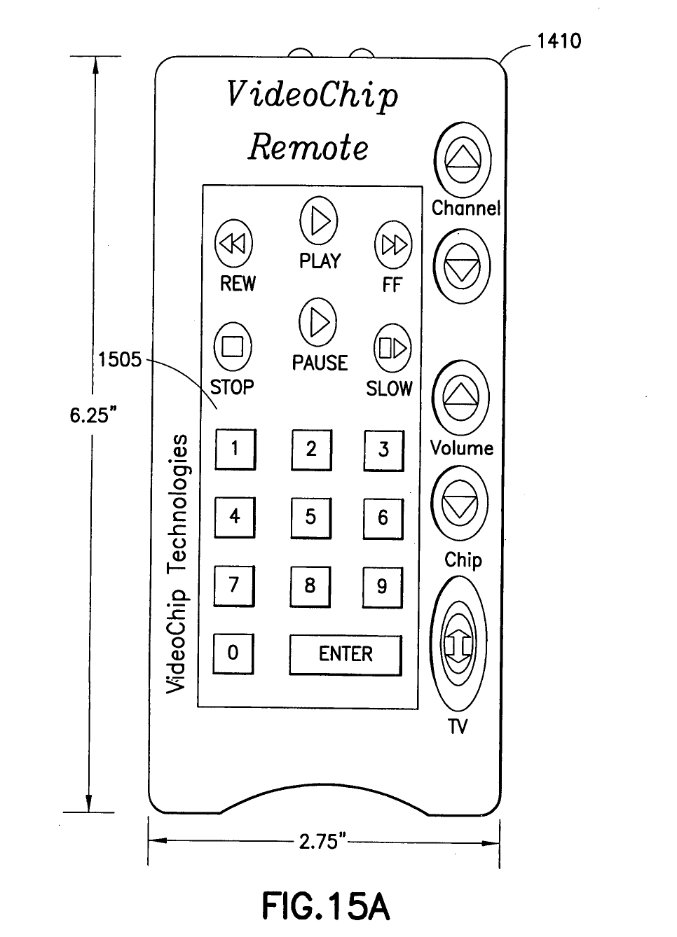

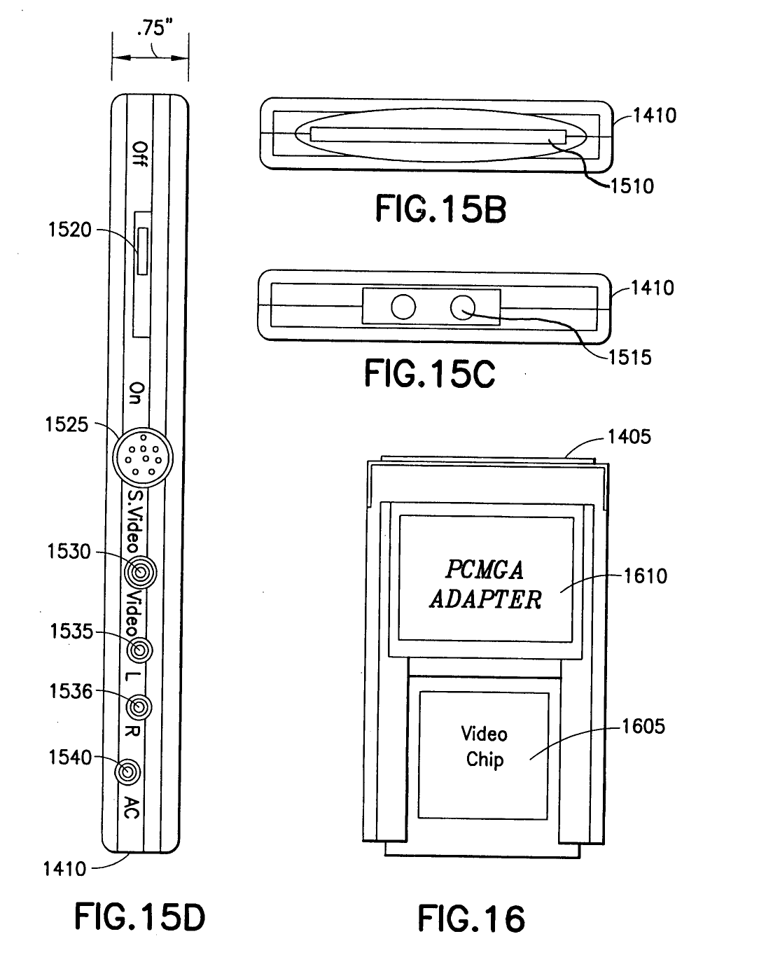

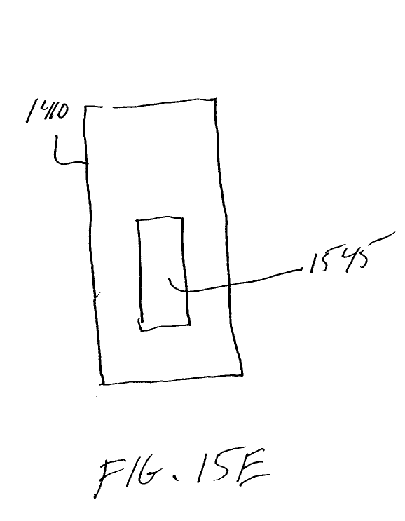

Referring to FIGS. 15A-15E, in one embodiment the universal remote control 1410 includes a keypad 1505, a media slot 1510, a wireless signal transmitter 1515, an on/off switch 1520, an S-video port 1525, an RCA video port 1530, left audio port 1535, right audio port 1536, an A/C adapter connector 1540, and a battery compartment 1545. The universal remote control 1410 also includes an internal microprocessor (not shown) and an internal PCMCIA interface (not shown) disposed in the media slot 1510 for interfacing with a PCMCIA adaptor on the memory device 1405 (discussed in detail below). The keypad 1505 includes standard keys for controlling a variety of audio/video devices (e.g., number keys, volume up/down, channel up/down, VCR/DVD function keys, and TV-A/V toggle key).

In one embodiment, the universal remote control 1410 transmits audio/video data (via a wireless signal) that is stored on the removable memory device 1405 to the set top box 1420, which functions to play/display the audio/video data on the television 1425, and is discussed in further detail below.

The media slot 1510 is configured to receive the memory device 1405. In one embodiment, the memory device 1405 includes a video chip 1605 and a PCMCIA adapter 1610 that is used to interface with the removable memory device 1405.

The removable memory device 1405 is a portable memory device. The video chip 1605 is a Mini SD, SD, Compact flash, Sony Stick, Memory Storage Card, mini hard drive, or any other known or hereafter developed memory storage device. The video chip is in communication with the PCMCIA adaptor 1610. The PCMCIA adaptor 1610 can be a type I-III adaptor, and is used to interface the video chip 1605 with the universal remote control 1410 when the removable memory device 1405 is plugged into the media slot 1510.

The removable memory device 1405 includes an entertainment application stored on the video chip 1605. The entertainment application may include a movie, cartoon, television program, song, amusement, or game. The entertainment application includes primary data 103 (see FIG. 1). The primary data 103 includes at least one media file, which can be an audio component or file, a video component or file, a video with audio component or file, and/or still images. The video and audio files include formats that are known in the art, such as .MPEG1-4, AVI, .WMV, .MOV, RA, .WMA, .MP3, .WAV, for example. The still image files include formats such as .JPEG, .TIFF, .BMP, GIF, etc. In one embodiment, the primary data 103 includes a plurality of formats of the media file.

The removable memory device 1405 also includes a script file or command file stored on the video chip 1605. The script file or command file is readable or executable by the set top box 1420 upon insertion of the removable memory device 1405 into the media slot 1510 or upon activating the set top box 1420 after the removable memory device. 1410 is inserted in the media slot 1510. The script file or command file includes a request for the set top box 1420 to display or play the media file. In other embodiments, the script file or command file includes instructions that enable the set top box 1420 to find and select from a plurality of media formats the correct media file with the proper format depending on the display device it is connected to.

In one embodiment, the removable memory device 1410 further includes a startup image stored on the video chip 1605. In this embodiment, the script file or command file includes a request for the set top box 1420 to display the startup image before displaying the media file. The startup can be a logo, a image of movie art, or an advertisement.

In another embodiment, the removable memory device 1410 further includes a menu image stored on the video chip 1605. The menu image is a list of available menu choices the user can select. The menu image displays items related to different sections of the media file. For example, the menu image may display a list of episodes of program. The use can select which episode he or she wants to view by using the keypad 1505. In this embodiment, the script file or command file includes a request for the set top box 1420 to display the menu image before displaying the media file.

In still another embodiment, the universal remote control device 1410 includes a decoder stored on the video chip 1605 or is part of the microprocessor. The decoder decodes the media file on the universal remote control device to produce decoded information that is capable of being transmitted to the set top box 1425 for display, or transmitted directly the video display when the universal remote control 1410 is connected directly to the video display. In another embodiment, the decoder resides on the set top box 1420.

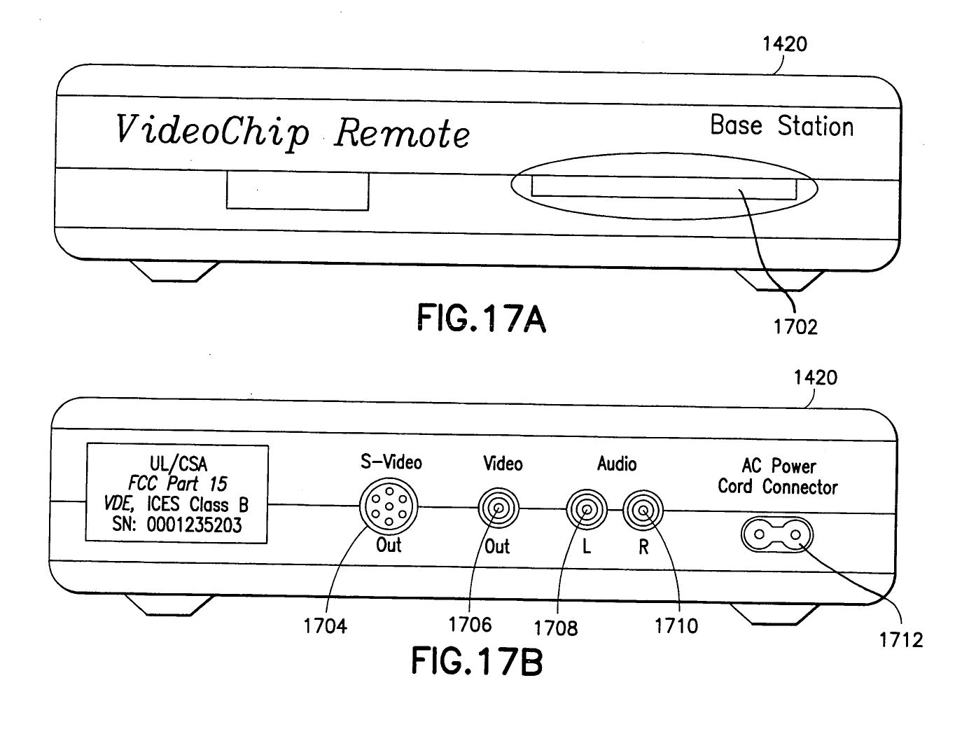

Referring to FIGS. 17A and 17B, in one embodiment, a set top box 1420 that is configured to receive wireless signals (e.g., IR or RF) from the universal remote control 1410 is shown. The set top box 1420 includes a media slot 1702, which functions similar to the media slot 1510 in the universal remote control 1410 described above. The set top box 1420 further includes an S-video port 1704, an RCA video port 1706, left audio port 1708, right audio port 1710, an A/C adapter connector 1712. These connections used to connect the set top box 1410 to a video monitor or television set 1425. The set top box 1420 also includes a microprocessor disposed internally (not shown). In some embodiments, the set top box 1420 includes an internal memory, such as ram or a hard drive for storing the media file after is has been received from the universal remote control 1410.

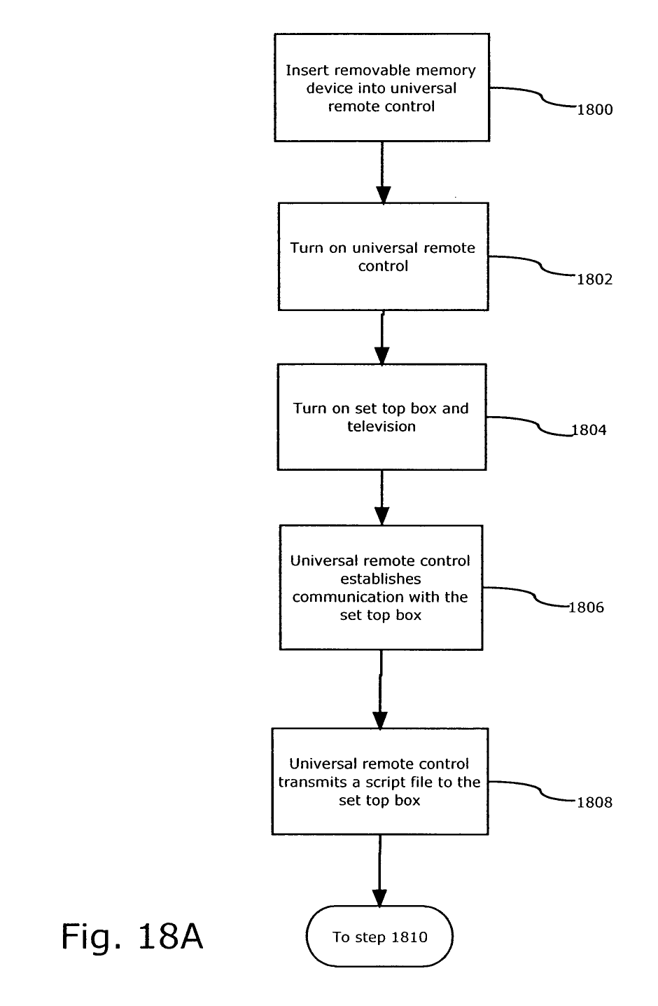

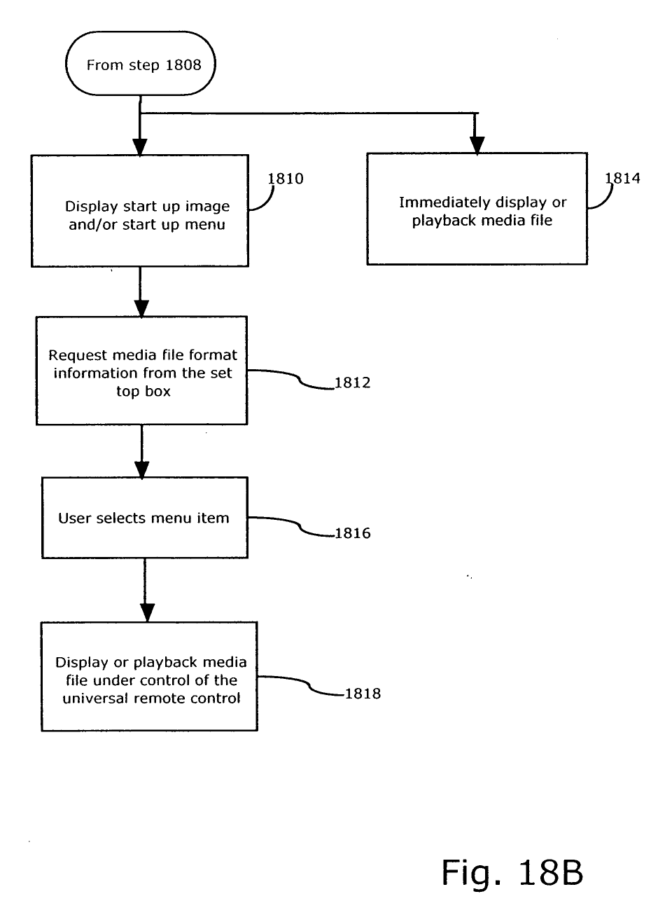

Referring to FIGS. 18A and 18B, a flow diagram of the operation of the universal remote control 1410 is shown. A user inserts a removable memory device 1405 into the media slot 1510 such that the PCMCIA interface 1610 contacts the PCMCIA interface that is disposed in the media slot 1510 (step 1800). The user then turns on the universal remote control 1410 via switch 1520 (step 1802). At the same time the set top box 1420 and connected televison 1425 are assumed to be also on, if not they are both turned on (step 804). The universal remote control 1410 establishes communication with the set top box 1420 via a wireless connection (e.g., IR or RF) (step 1806). The universal remote control 1410 transmits a script file or command file to the set top box 1420 (step 1808). This file includes commands that instruct the set top box 1420 to perform various functions. For example, as previously described, the script file or command file can instruct the set top box 1420 to display a start up image and/or a menu image before displaying or playing the media file (step 1810). The script file or comand file can also request information from the set top box 1420 regarding what format the set top box 1420 is compatible with (step 1812). In this case, the universal remote control 1410 would select the proper media file to transmit to the set top box 1420, or instruct the set top box 1420 as to what memory location on the video chip 1605 the proper media file is stored all thus allowing the set top box 1420 to retrieve the correct media file.

As previously described, the set top box 1420 can be instructed to immediately start displaying or playing the media file (step 1814). Alternatively, if the set top box 1420 has been instructed to display a menu, the set top box 1420 will wait until the user selects a menu item for display or playback.

The user then selects a menu item for display (e.g., a movie or program episode) or playback (e.g., an audio file such as a movie soundtrack) (step 1816). Thereafter, the set top box 1420 functions as a typical VCR or DVD player with fuctions that the user controls via the universal remote control 1410 (step 1818).

In another embodiment, if the entertainment application is a game, the keypad 1505 on the universal remote control 1410 is used to control the game features under the direction of a specific script or command file.

In addition to the above-described functions, the universal remote control 1410 is capable of being programmed to operate any other home entertainment device. In one embodiment, programming the universal remote control 1410 is accomplished by the user pressing a sequence of buttons on the keypad 1505 to activate a programming mode, entering a code that corresponds to the A/V device to be controlled by the universal remote 1410, and pressing a sequence of buttons on the keypad 1505 to disable programming mode. This, and other methods of programming a universal remote to control any AN device are known to those skilled in the art.

In another embodiment, the universal remote control 1410 can be connected directly to a video monitor or television set via the S-video port 1525 or the RCA video port 1530, and the left audio port 1535 and the right audio port 1536. In this embodiment, the universal remote control decodes and transmits the media file directly to the television. The display or playback of the media file is the same as previously described with respect to the set top box 1420, except all processing is done on the microprocessor in the universal remote control 1410.

In one embodiment, the universal remote control 1410 is powered by batteries that are installed in the battery compartment 1545. This allows the universal remote control 1410 to used as a portable media display and playback device. The universal remote control 1410 can be turned on and off via the on/off switch 1520 to conserve battery power. In another embodiment, the universal remote control 1410 is powered via the A/C adaptor connector 1540 with an A/C adaptor. In still another embodiment, rechargeable batteries are provided in the battery compartment 1545 and the A/C adapter is connected to the A/C adaptor connector 1540 from time to time to recharge the rechargeable batteries.

In another embodiment, the universal remote control 1410 and/or set top box 1420 include an autorun application for automatically displaying or playing the media file stored on the memory device 1405 when the memory device 1405 is inserted into the media slot 1510 or 1705.

In still another embodiment, the universal remote control 1410 includes limited processing capabilities. In this embodiment, the memory device 1405 runs an application upon being inserted into the media slot 1510. The application generates a signal or other instruction that is transmitted to the set top box 1420. In response to the transmitted signal or instruction, the set top box 1420 plays or displays the media file, or executes a game application.

In other embodiments, the universal remote control 1410 can be used to play or display a media file as described above on any of a variety of host devices such as digital cameras, laptop and desktop computers, PDAs, cell phones, etc., as long as the particular host device is capable of receiving a wireless signal (e.g. IR or RF).

In this embodiment, the memory device 1405 includes a plurality of instruction sets. Each of the instructions sets are associated with a particular host device or family of host devices and are used to control particular host devices. For example, the instructions transmitted from the universal remote control 1410 may instruct the host device to use instruction set 1 stored at address 1234 if the host device is a SONY camera and use instruction set 2 stored at address 4231 if the host device is a PANASONIC camera. Although only two instruction sets are described in the above embodiment, any number of instruction sets may be included and are limited only by the available memory space on the memory device 1405. Furthermore, one or more generic sets of instructions may be included for devices that are not specifically listed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A universal remote control device, comprising:
means for communicating with a host device, the host device including a video display, audio output, and a microprocessor; and
a media slot configured to receive a removable memory device, the removable memory device comprising:
an entertainment application comprising primary data comprising at least one media file; and
a script file or command file that is readable or executable by the remote control device or the host device upon insertion of the removable memory device into the media slot or upon activating the remote control device or the host device after the removable memory device is inserted in the media slot, the script file or command file including a request for the host device to display or play the at least one media file.

2. The universal remote control device of claim 1, wherein the removable memory device further comprises a startup image and the script file or command file further comprises a request for the host device to display the startup image before displaying the at least one media file.

3. The universal remote control device of claim 1, wherein the removable memory device further comprises a menu image of available menu choices and the script file or command file further comprises a request for the host device to display the menu image before displaying the at least one media file.

4. The universal remote control device of claim 1, wherein the primary data further comprises a plurality of formats of the at least one media file, and the script file or command file further comprises instructions enabling the host device to locate an appropriate one the plurality of formats of the at least one media file.

5. The universal remote control device of claim 4, wherein the script file or command file further comprises instructions for enabling the host device to determine which one of the plurality of formats to use.

6. The universal remote control device of claim 1 further comprising a decoder for decoding the at least one media file on the universal remote control device to produce decoded information that is capable of being transmitted to the host device for display.

7. The universal remote control device of claim 1, wherein the removable memory device is a portable memory device.

8. The universal remote control device of claim 1, further comprising a file that is executable on the removable memory device.

9. The universal remote control device of claim 1, wherein the removable memory device comprises one of mini SD, SD, compact flash, memory stick, memory storage card, or mini hard drive.

10. The universal remote control device of claim 1, wherein the host device is a mobile terminal.

11. The universal remote control device of claim 1, wherein the host device is one of a mobile phone, digital camera, and personal digital assistant.

12. The universal remote control device of claim 1, wherein the host device is a television.

13. The universal remote control device of claim 1, wherein the host device is a set top box in communication with a television or a video monitor.

14. A method of displaying or playing an entertainment application on a host device, comprising:
providing a removable memory device comprising a script file or command file, and an entertainment application comprising primary data comprising at least one media file;
providing a universal remote control device comprising a media slot configured to receive the removable memory device, the script file or command file being readable or executable by the remote control device or the host device upon insertion of the removable memory device into the media slot or upon activating the remote control device or the host device after the memory device is inserted in the media slot, the script file or command file comprising a request for the host device to display or play the at least one media file;
inserting the removable memory device into the media slot;
providing to the host device, by the universal remote control device, the request for the host device to display or play the at least one media file; and
displaying or playing by the host device the at least one media file in response to the request.

15. The method of claim 14, wherein the removable memory device further comprises a startup image and the step of displaying comprises displaying, by the host device, the startup image prior to displaying or playing the at least one media file.

16. The method of claim 15, wherein the step of displaying or playing comprises displaying or playing the at least one media file in response to the request after the startup image is displayed and after a user inputs a display or play command to the universal remote control device.

17. The method of claim 16 wherein the user input is provided using manipulable buttons or switches disposed on the universal remote control device.

18. The method of claim 15 wherein the user input is provided using a touch screen on the host device.

19. The method of claim 14, wherein the memory cartridge further comprises a menu image and the step of displaying or playing further comprises displaying, by the host device, the menu image prior to displaying or playing the at least one media file in response to the request.

20. The method of claim 19, wherein the menu image displays at least one item related to a section of the at least one media file, and the step of displaying or playing further comprises displaying or playing the at least one section of the at least one media file in response to a user input.

21. The method of claim 14, wherein the script file or command file further comprises a separate request for each of a plurality of different host devices or for each of a plurality of groups of devices.

22. The method of claim 21 further comprising providing a decoder on the universal remote control device for decoding the at least one media file on the universal remote control device.

23. The method of claim 14, wherein the universal remote control device further comprises a decoder, and the step of displaying or playing comprises decoding the at least one media file and transmitting a stream of decoded data from the universal remote control to the host device for display or playback.

24. The method of claim 14 further comprising providing instructions to the host device by executing a program on the universal remote control device and transmitting the instructions to the host device.

25. The method of claim 14, wherein the step of displaying or playing further comprises pausing the displaying or playing of the at least one media file in response to a user input command to revert to the normal function of the host device.
